(19) United States
(12) Patent Application Publication
(10) Pub. No.: US 2022/0402820 A1
(43) Pub. Date: Dec. 22, 2022

(54) NOVEL CEMENTITIOUS COMPOSITION

(71) Applicant: UNIVERSITY OF PRETORIA, HATFIELD, PRETORIA (ZA)

(72) Inventor: MAXIM NIKOLAEVICH KOVTUN, CAMMERAY, NEW SOUTH WALES (AU)

(21) Appl. No.: 17/770,824

(22) PCT Filed: Nov. 4, 2020
(86) PCT No.: PCT/IB2020/060350

§ 371 Date: Apr. 21, 2022

(30) Foreign Application Priority Data
Nov. 5, 2019 (ZA) 2019/07315

(51) Int. Cl. C04B 28/18; C04B 22/10; C04B 22/06

(52) U.S. Cl. CPC C04B 28/18; C04B 22/10; C04B 22/064

(57) ABSTRACT

The present invention relates to the field of cementitious compositions. Particularly, the invention concerns an alkaline-activated fly ash cementitious composition and the use of this composition as a binder in concrete production.

### TECHNICAL FIELD

The present invention relates to the field of cementitious compositions. Particularly, the invention concerns an alkaline-activated fly ash cementitious composition and the use of this composition as a binder in concrete production.

### BACKGROUND ART

Global utilization and consumption of concrete is only second to water. It is the crucial building material to give rise to society's infrastructures all around the world. Approximately 25 billion tonnes of concrete are produced annually on a global scale. This is equivalent to over 1.7 billion truck loads per year or about 6.4 million truck loads a day or over 3.8 tonnes per person around the globe each year (WBSCD, 2009; Madlool et al., 2011).

With such high volumes of concrete produce, it significantly increases the production of cement. Cement acts as an adhesive to bind the constituents in the concrete mix. It comprises of approximately 5-20% of concrete.

Cement production contributes 5-7% of all anthropogenic CO₂ emissions worldwide. One ton of cement manufacture produces approximately 0.7-0.9 ton of CO₂ emissions. In southern Africa, it was reported that CO₂ emissions were 753 kg per ton of cement manufactured.

The production of clinker, an intermediate product in cement manufacture, is the most energy-intensive step that accounts for roughly 80% of the cement production (Zhu, 2011). Approximately 50% of carbon emissions, during the fabrication process, originate from decomposition of raw materials to form clinker. Combustion of fossil fuels in pyro-procession units release 40% of emissions. The last 10% are due to transportation of raw materials and electricity consumed by electrical motors and facilities (Ali et al., 2011; Turner & Collins, 2013; Benhelal et al., 2013).

A large portion of CO₂ is released during calcination of limestone at 900° C. It converts carbonates to oxides and CO₂ forms as a by-product in the chemical reaction. The simplified stoichiometric relationship can be expressed as:

CaCO₃+heat→CaO+CO₂↑ (1)

About 64-67% of clinker comprises of calcium oxide (CaO) while the rest are iron oxides and aluminium oxide. This amounts to roughly 0.5 kg of CO₂ that is produced per kg of clinker and emissions are dependent on clinker to cement ratio. Furthermore, it is estimated that 0.65-0.9 tonne of CO₂ is produced per ton of cement depending on the type of fuel used, modern technology and equipment (Turner & Collins, 2013; Ali et al., 2011; Gibbs et al., 2000; Gao et al., 2014).

Since CO₂ emissions contribute to 65% of global warming, it has become imperative that alternative methods be established to reduce the carbon footprint. To further justify the need for substitutes, ordinary Portland cement (OPC) is subjected to certain limitations. These limitations include durability issues due to its intrinsic properties, high permeability that can cause carbonation and corrosion problems and alkali-silica reactions (Torgal et al., 2008).

An alternative to OPC cements are blended cements, which are expected to significantly reduce cement use. Cement is partially replaced by supplementary cementitious binder materials based on waste by-products such as fly ash (FA) and granulated blast furnace slag (GBFS). Another alternative cementitious binders are alkali-activated aluminosilicate materials (Turner & Collins, 2013; Rashad, 2014).

Alkali-activated materials (AAM) are one of those alternative binders that have shown similar and at times better mechanical properties than Portland cement with lower carbon emissions. Since AAM utilize source materials rich in Al and Si, it provides an opportunity to use by-products from different processes such as FA, silica fume (SF) and GBFS.

Fly ash is a fine powder that is created as a by-product through the burning of pulverized coal in thermal power plants for producing electricity. In South Africa, Eskom is the entity responsible for generating electricity for the country and are the largest coal consumers. The company reports that the production of FA is approximately 35 million tonnes yearly, of which only 7% gets recycled. The rest gets discarded in massive landfills, which causes numerous environmental problems that is quickly becoming a cause of concern. South Africa has implemented a plan known as The South African National Development Plan 2030 (NDP), which places a specific attention to reduce the waste-to-landfill problem in the country. Since AAM requires by-products such as FA for its production, it can aid in recycling the FA whilst providing an adequate building material. This will promote a drive towards the strategic initiative set out by the NDP and also towards a global reduction in CO₂ emissions.

However, alkali-activated materials have a slow rate of adaptation into the industry. This is primarily caused by the fact that AAM's require controlled environments to produce and is highly variable due to the binder's chemical composition. Furthermore, to achieve sufficient strength and mechanical properties, it is often required that FA based AAM's be cured under elevated temperature conditions, which is something not readily available on site and impedes its range of application.

Thus, it is imperative that newer and detailed methods be developed to further drive its acceptance. There are numerous studies into unary and binary blends. Unary blends such as alkali-activated fly ash (AAFA) and alkali-activated slag (AAS) have a distinct set of advantages and limitations. GBFS based AAM can attain relatively high strength under ambient conditions but due to its high reactivity, it is prone to rapid setting, shrinkage and microcracks. GBFS is also not available abundance and is more expensive than FA. Thus, FA based AAM prove to be a more efficient type of binder to use. However, AAFA have low reactivity under ambient conditions, which restricts its application to the pre-cast industry.

Various patent documents teach of the use of AAFA in this field. In particular, Chinese patents CN105523723; CN106746826; CN104829200; CN102303036; CN101880151 and CN101830653 and US patent U.S. Pat. No. 5,565,028 disclose AAFA to produce alkali-activated cementitious compositions. None of these prior art documents teach of a cementitious composition whereby the materials are combined in one step in situ.

In view of the foregoing discussion, there is thus a clear need in the art for an improved concrete composition that does not suffer from the disadvantages and shortcomings associated with conventional compositions and the teachings of the prior art.

The present invention thus aims to solve said disadvantages and shortcomings in the prior art by providing a novel cementitious composition.

### SUMMARY OF THE INVENTION

According to a first aspect of the invention, there is provided a cementitious composition which includes:
a binder consisting of a source of fly ash and a source of amorphous (reactive) silica; and
a chemical activator,
   wherein
the chemical activator comprises a combination of Na₂CO₃ and a source of calcium, the source of calcium is selected from the group consisting of Ca(OH)₂, CaO, or a mixture thereof; and
the composition is cured at ambient or elevated temperature and used for in situ or precast applications.

It will be appreciated that any suitable source of fly ash may be used, including but not limited to unclassified fly ash (UFA), classified fly ash (CFA) and a combination thereof.

In an embodiment, the source of amorphous (reactive) silica present in the composition may be from 1 to 20 wt % of fly ash mass.

In an embodiment, the Na₂CO₃ present in the composition may be between 3 and 15 Na₂O_{eq} wt % of fly ash mass.

In an embodiment, the source of calcium present in the composition may be between 3.5 and 20 CaO wt % of fly ash mass.

In an embodiment, the composition may be cured at ambient temperature in situ on, for instance, a construction site. It also can be cured at elevated temperature at a precast production site.

In an embodiment, the present invention provides for the composition, as disclosed herein, for use as a one-part “just add water” cementitious composition.

According to a second aspect of the invention, there is provided the use of the cementitious composition, as defined and described in accordance with the first aspect of the present invention, in the manufacture of concrete, mortar, grout and the like.

According to a third aspect of the invention, there is provided a process for the preparation of a dry mixed ready-to-use cementitious composition, the process including the steps consisting of:
(i) providing a binder consisting of a source of fly ash and a source of amorphous (reactive) silica;
(ii) providing a chemical activator comprising a combination of Na₂CO₃ and a source of calcium, the source of calcium is selected from Ca(OH)₂, CaO, and a mixture thereof; and
(iii) mixing the binder and chemical activator in one step.

According to a fourth aspect of the invention, there is provided a concrete, mortar or grout product or the like prepared according to the process as defined and described in accordance with the third aspect of the present invention.

These and other aspects of the present invention will now be described in more detail herein and below.

### BRIEF DESCRIPTION OF THE FIGURES

The invention will now be described in more detail, by way of example only, with reference to the accompanying figures in which:

FIG. 1: represents a 2-level CCD design space;

FIG. 2: represents a 3-level face-centred CCD design space;

FIG. 3: is a graph of 28-day compressive strength of samples;

FIG. 4: depicts the main effect of variables;

FIG. 5: is an interaction plot between Ca(OH)₂ and Na₂CO₃;

FIG. 6: represents the interaction between Na₂CO₃ and silica fume;

FIG. 7: represents the interaction between silica fume and Ca(OH)₂;

FIG. 8: is a normal probability plot;

FIG. 9: is a graph of residuals versus fits;

FIG. 10: is a graph of residuals versus order;

FIG. 11: shows surface and contour plots of Na₂CO₃ and Ca(OH)₂ with silica fume held at a) 5 wt %, b) 10 wt % and c) 15 wt %;

FIG. 12: is X-ray diffractograms of chosen samples at 3 and 28 days;

FIG. 13: shows SEM images of chosen samples at 3 and 28 days;

FIG. 14: is a FTIR spectrum for SC12|CH20|SF5 at different curing ages;

FIG. 15: is a FTIR spectrum for SC12|CH10|SF5 at different curing ages;

FIG. 16: is a FTIR spectrum for SC6|CH20|SF5 at different curing ages;

### EXAMPLES OF THE INVENTION

The invention will now be described with reference to the following non-limiting examples.

1.1. Experimental Setup

The experimental setup dealt with performing a detailed analysis of the novel composition of the present invention by mathematical design of experiments (MDE). Central composite designs (CCD), also known as Box-Wilson designs, are highly efficient and flexible. MDE allows for modelling and analysis of the response of interest as well as providing satisfactory information on the experimental variables and their effects and error with minimal number of runs.

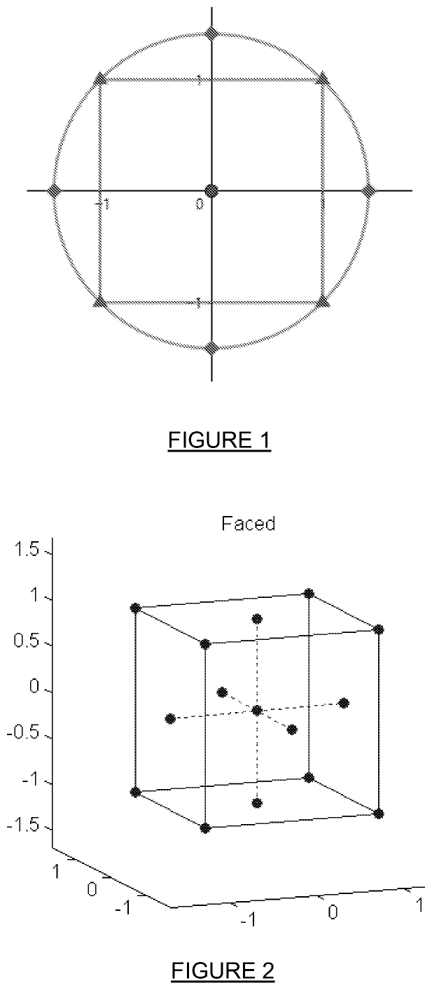

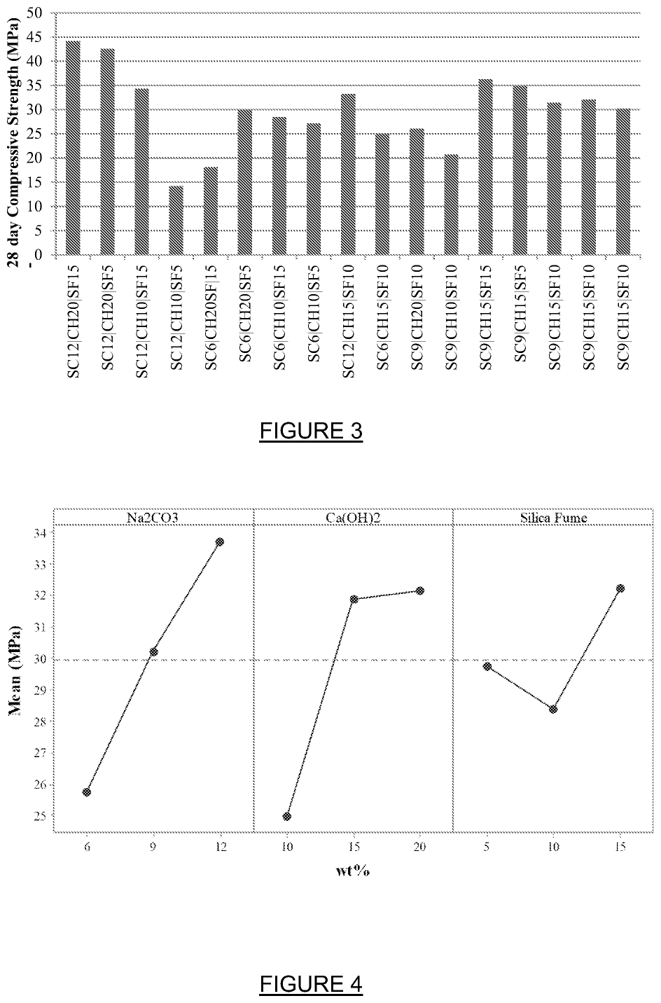

CCD included an embedded factorial or fractional factorial design with centre points that is augmented with a group of axial/star points that allows curvature estimation. This type of design can be used to estimate the first- and second-order terms/effects as well as model a response variable. Using a 2-level CCD example, it will contain a centre point (circle), four factorial points at its corners (the +1 and −1 coded variable levels shown by triangles) and four axial/star points (diamond) that lie a distance +α and −α on each axis. This is shown in FIG. 1.

There are three kinds of CCD (inscribed, circumscribed, faced) where each type uses a different a value. For this experimental design, a face-centred CCD (α=±1) was chosen as the region of interest encompasses the extremities and a 3^{k} level CCD was chosen. A visual representation of the box is shown in FIG. 2.

As mentioned earlier, a 3-level CCD with 3 centre point runs was chosen for the experimental program. Table 1 states the chosen control and response variables and the constant parameters. Table 2 gives the coded values of the control variables and Table 3 states the values of the constant parameters.

TABLE 1
Chosen parameters for CCD

| Control variables | Response variable | Constant parameters |
|---|---|---|
| Ca(OH)₂ content | 28-day compressive | Curing condition |
| Na₂CO₃ content | strength | W/B ratio* |
| Silica Fume content | | Mixing time |

*Water-to-binder ratio, where binder is sum of all dry materials (fly ash, silica fume, calcium hydroxide and sodium carbonate)

TABLE 2
Coded and uncoded control variables

| Control variables* | −1 | 0 | +1 |
|---|---|---|---|
| Ca(OH)₂, wt % | 10 | 15 | 20 |
| Na₂CO₃**, wt % | 6 | 9 | 12 |
| Silica Fume, wt % | 5 | 10 | 15 |

*wt % = calculated as a percentage of fly ash content
**Calculated as Na₂O_{eq}

TABLE 3
Constant parameter values

| Parameter | Value |
|---|---|
| Curing condition | Ambient temperature |
| W/B ratio | 0.27 |
| Mixing time | 5 minutes |

The choice of the response variable is dependent on the system being studied. Mechanical strength provides a satisfactory indication of the degree of reaction of the system's final product, alkali aluminosilicate gel. For this experimentation, the average of three compressive strength tests done on different days in accordance to SANS 50196-1. Control variables calcium hydroxide, sodium carbonate and silica fume were chosen to be the significant factors to affect the strength gain.

Unlike GBFS, which has latent hydraulic properties due to its high calcium content, fly ash is shown to have pozzolanic activity and will exhibit cementitious properties in the presence of lime, hence the addition of Ca(OH)₂ as a control variable. However, the activation of fly ash with Ca(OH)₂ has low strength development. Shi & Day (2000) used different chemical activators to improve the strength development of FA-Ca(OH)₂ binder system. The authors incorporated Na₂SO₄ to increase the pH of the solution as the addition of Na₂SO₄ with Ca(OH)₂ gives the chemical reaction:

Na₂SO₄+Ca(OH)₂+2H₂O↔CaSO₄.2H₂O↓+2NaOH (2)

The formation of NaOH is responsible for increasing the pH of the solution, promoting an increase in the degree of early activation. However, the use of Na₂SO₄ produces durability problems such as sulfate attack; and thus Jeon et al. (2015) incorporated the use of Na₂CO₃. The authors found that the same pH increasing effect was present and there was a noticeable improvement in the compressive strength. Jeon et al. (2015) state the strength was approximately 4-5 times higher than samples containing no Na₂CO₃. Thus, to further quantify the effect, this experimentation used different amounts of Ca(OH)₂ and Na₂CO₃ to see the variability in the results.

In Jeon et al. (2015) investigation, the system was thermally activated. However, the aim of this research is to produce a binder than can be cured at ambient conditions on site. Thus, curing conditions were limited to ambient temperature of 25±1° C. and relative humidity of 85±5%.

1.2. Materials

Fly ash, sodium carbonate, hydrated lime and silica fume were procured from local distributors in South Africa. Table 4 represents the chemical composition of fly ash and silica fume.

TABLE 4
Chemical composition of source materials

| % | Fly ash | Silica fume |
|---|---|---|
| SiO₂ | 56.23 | 88.86 |
| TiO₂ | 1.57 | 0.01 |
| Al₂O₃ | 30.67 | 0.60 |
| Fe₂O₃ | 4.45 | 4.63 |
| MnO | 0.04 | 0.13 |
| MgO | 0.49 | 1.03 |
| CaO | 4.54 | 1.86 |
| Na₂O | 0.27 | 0.28 |
| K₂O | 0.81 | 2.03 |
| P₂O₅ | 0.24 | 0.08 |
| Cr₂O₃ | 0.03 | 0.01 |
| SO₃ | 0.37 | — |
| LOI | 0.28 | 4.58 |
| TOTAL | 99.99 | 99.54 |

1.3. Sample Preparation and Testing Procedures

1.3.1. Design Matrix and Sample Preparation

The binder components (FA, SF, Ca(OH)₂ and Na₂CO₃) were intermixed in a ball mill for approximately 5 minutes to limit the effect of grinding on performance of the binders.

The design matrix of the face-centred CCD with 3 centre points is shown in Table 5.

TABLE 5
Coded variables for CCD

| Design Points | Run Order | Mix ID | SC | CH | SF |
|---|---|---|---|---|---|
| 1 | 2 | SC12\|CH20\|SF15 | +1 | +1 | +1 |
| 2 | 5 | SC12\|CH20\|SF5 | +1 | +1 | −1 |
| 3 | 17 | SC12\|CH10\|SF15 | +1 | −1 | +1 |
| 4 | 9 | SC12\|CH10\|SF5 | +1 | −1 | −1 |
| 5 | 3 | SC6\|CH20SF\|15 | −1 | +1 | +1 |
| 6 | 10 | SC6\|CH20\|SF5 | −1 | +1 | −1 |
| 7 | 11 | SC6\|CH10\|SF15 | −1 | −1 | +1 |
| 8 | 6 | SC6\|CH10\|SF5 | −1 | −1 | −1 |
| 9 | 12 | SC12\|CH15\|SF10 | +1 | 0 | 0 |
| 10 | 4 | SC6\|CH15\|SF10 | −1 | 0 | 0 |
| 11 | 16 | SC9\|CH20\|SF10 | 0 | +1 | 0 |
| 12 | 15 | SC9\|CH10\|SF10 | 0 | −1 | 0 |
| 13 | 1 | SC9\|CH15\|SF15 | 0 | 0 | +1 |
| 14 | 7 | SC9\|CH15\|SF5 | 0 | 0 | −1 |
| 15 | 12 | SC9\|CH15\|SF10 | 0 | 0 | 0 |
| 16 | 14 | SC9\|CH15\|SF10 | 0 | 0 | 0 |
| 17 | 8 | SC9\|CH15\|SF10 | 0 | 0 | 0 |

SC - Sodium Carbonate;
CH - Calcium Hydroxide;
SF - Silica Fume

The replication of the centre point runs provides an estimate of the experimental error. The face-centred CCD was performed in random order to eliminate the possibility that one run depends on the conditions of the previous run or have an influence of subsequent runs.

Binder pastes were mixed in a Hobart mixer. The dry binder was added to a damp bowl and then water was added with the mixer running. Mixing was done for 5 minutes and then mixer was stopped and all dry material was scrapped off the bowl surface. The mixer was run again for another 5 minutes until the paste was completely mixed.

Prismatic moulds were used to cast 40×40×160 mm samples. The pastes were placed in the moulds, compacted on a vibrating table until there were no air bubbles, covered in film and left to set overnight at 25±1° C. The samples were then demoulded the following day and cured in a room with an ambient temperature of 25±1° C. and relative humidity of 85±5%. The samples were first weighed in air then weighed in water before strength tests were conducted. Compressive strength tests were carried out on three halves of the prism samples at 3, 7 and 28 days. The test procedure was done in accordance to SANS 50196-1.

1.3.2. Statistical Analysis Procedure

The first stage of statistical analysis deals with interpreting the variable effects. This aids in providing necessary information on which variables and interactions may prove to be important terms to include in the model.

Thereafter, the initial model is formed which is a full model with all factors and interactions included. For this investigation, a full quadratic model was chosen to include possibility of curvature. Then analysis of variance (ANOVA) is applied to test the significance of the model. This is quantified by looking at the p-value, which is the converted F-statistic that is derived from the mean squares. If the p-value is less than 0.05, the model (and its terms) is deemed significant. If it is greater than 0.1, then the model terms are statistically insignificant. The next stage deals with model refinement where insignificant terms in the model are removed and ANOVA tests run until only significant terms remain in the model.

Thereafter, residual plots are analysed to confirm model assumptions and check its adequacy. This is an important part of the statistical analysis as it examines whether the model in question provides an adequate representation of the true system and it does not violate the least squares regression assumptions. The least squares regression assumptions are:

1. Normality assumption;

2. Constant variance assumption;

3. Independence assumption.

The normality assumption is checked with the normality probability residual plot. If the graph follows a straight line then the assumption holds true and the model follows a normal distribution. If there is a s-shape or any abnormal shape then the normality assumption is violated.

The constant variance assumption is validated by the residuals versus predicted response graph. This plot should show a random scatter to satisfy the assumption. A presence of any sort of trend such as a megaphone shape indicates the assumption does not hold true and suggests an inequality of variance.

Plotting the residuals versus experimental run validates the independence of assumption, which again should show a random scatter with no noticeable trends. If all the assumptions hold true then the model can be deemed adequate and analysis of response surfaces and contour plots can be performed (Montgomery, 2011).

1.3.3. Characterization Techniques

Characterization techniques of X-Ray Diffraction (XRD), Fourier-Transform Infrared Spectroscopy (FTIR) and Scanning Electron Microscopy (SEM) were performed. These techniques were used to evaluate the microstructural and mineralogical changes over time for selected samples at 3 and 28 days. This provides information on the different compressive strength values observed during the study.

The samples required to be prepared before the characterisation techniques could be conducted. After being tested for strength at 3 and 28 days, representative samples for selected binders were collected, then they were dehydrated to prevent further material evolution. This was achieved by placing the samples in acetone to stop the hydration and then transferred to a vacuum chamber to filter out the acetone. Thereafter, the samples were placed in a desiccator at 25° C. to completely dry the sample until testing date (Ismail, et al., 2013). Samples for XRD and FTIR require the material to be in powdered form. This was attained by hand milling the dried samples using a pestle and mortar.

X-Ray diffraction analysis (XRD) allows for crystalline phase determination. The samples were prepared according to the standardized PANalytical back-loading system, which provides nearly random distribution of the particles. The samples were analyzed using a PANalyticalX′Pert Pro powder diffractometerin θ-θ configuration with an X′Celeratordetector and variable divergence- and fixed receiving slits with Fe filtered Co-Kα radiation (λ=1.789 Å). The phases were identified using X′PertHighscore Plus software. The data was recorded in the angular range 5°<2Θ<90°. The relative phase amounts (wt %) were estimated using the Rietveld method (X′PertHighscore Plus software).

Microstructure evolution can be further studied with Fourier-Transform Infrared Spectroscopy (FTIR). This characterisation technique provides information on the vibrations generated by the chemical bonds in a material. Lee and Van Deventer (2002) comment that it is necessary to follow the progressive change of chemical bonds within a structure and then correlate that with the physical characteristics observed. Criado et al. (2012) discovered a correlation between the pendulum movement of the main band of the FTIR spectra and compressive strength development of alkali-activated fly ash, over time. The FTIR of the selected samples was recorded on a solid state by a VERTEX 70v spectrometer equipped with the Golden Gate diamond ATR cell (Bruker). FTIR was recorded on the 4000-400 cm⁻¹ spectral region, with 32 acquisitions at a 4 cm⁻¹ resolution. Chemical bonds that correspond to the spectra bands were identified according to literature.

The SEM analysis was conducted on Zeiss Ultra plus SEM at an accelerating voltage of 1 kV. The SEM images were captured for fractured samples.

1.4. Results and Discussion

1.4.1. Face-Centred CCD Results and Analysis

The computer software, Minitab® 17.1.0, was used to assist in the design, analysis and interpretation of the 3^{k} face centred central composite design. The model was analysed first as a full quadratic model which includes first- and second-order terms as well as two-factor interaction terms. This was done to incorporate any presence of curvature in the system.

It is often required that the impact of different factors be expressed as effect sizes and represented graphically. This helps in understanding which factor did or did not significantly influence the response, which was the 28-day compressive strength. The main factor effects can be calculated as the difference between the factor average and the grand mean. This is represented graphically in FIG. 4.

The graph in FIG. 4 is known as a main effects plot. It gives a visual representation of the relationship between the response and the independent variables. The dashed horizontal line represents the grand mean and the dots show the response mean at each factor level. The slope of each line visually indicates the impact. A horizontal line (parallel to the x-axis) implies no main factor effect and the response mean is the same across all factor levels. Non-horizontal lines imply there are main factor effects. The steeper the slopes of the line, the larger the effect and thus a greater impact on the response.

From FIG. 4, it can be noticed that Na₂CO₃ and Ca(OH)₂ have a positive impact on the compressive strength. Silica fume, on the other hand, has a negative impact at one factor level but a positive effect at another. Sodium carbonate has increasing slope at each factor level showing that higher quantity of Na₂CO₃ provides a beneficial effect towards strength development. Calcium hydroxide has a large effect on the strength when increasing from 10 to 15 wt % but a much smaller yet still positive effect from 15 to 20 wt %. Silica fume shows a negative impact when amount is increased from 5 to 10 wt % but it is counteracted with a larger positive effect when increased from 10 to 15 wt %.

However, if there are significant interaction terms then it is not possible to fully interpret the main effects without looking at the interaction plots.

An interaction plot shows the relationship of how one factor and the response depends on the value of another factor. For interaction plots, analysis is conducted by looking at both lines of an interaction and compared. If both lines are parallel then the interaction effect is concluded to be zero. However, the more different and steeper the slopes become, the greater the influence it has on the results. Furthermore, if the lines cross each other, it is known as disordinal interactions and if they do not then they are called ordinal interactions (Stevens, 2000). Each criterion alters how the factors are interpreted.

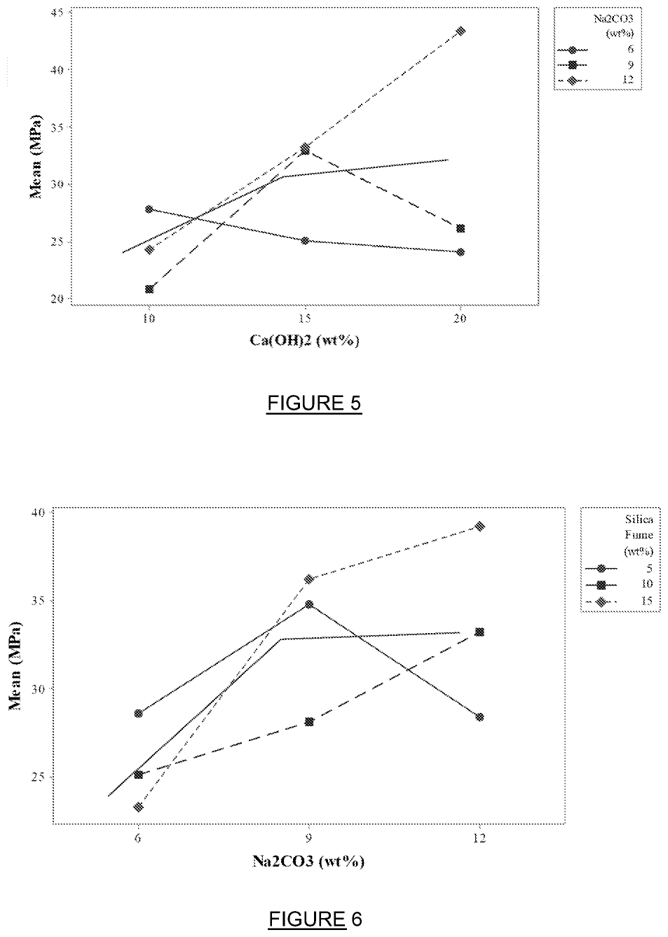

From FIG. 5, it can be noticed that none of the lines are parallel. Sodium carbonate (Na₂CO₃) at 12 wt % gives higher mean strength at two factor levels, 15 and 20 wt %, of Ca(OH)₂ except at 10 wt %, where Na₂CO₃ at 6 wt % gave a higher mean value. Sodium carbonate at 12 wt % factor level is always higher than at 9 wt % factor level which is higher than 6 wt % except 10 wt % Ca(OH)₂ factor level and even crosses the other lines. This shows that there is a possibility of a significant interaction as the relationship between Ca(OH)₂ and strength is dependent on the value of Na₂CO₃.

As there are interaction effects, it is possible to deduce simple main effects and check whether it is significant or not. This is evaluated by looking at the average of the circle, diamond and square points at each factor level on the x-axis and comparing them. This is shown by the purple line in FIG. 5. If there is a large enough change between each factor level, then the main effect can be deemed possible. The average of the points of Ca(OH)₂ at each factor level show that it generally increases, especially between 10 and 15 wt % but less between 15 and 20 wt %. This is confirmed with the main effects plot in FIG. 4 and shows Ca(OH)₂ as a possible main effect.

From FIG. 6, it can be again noticed that none of the lines are parallel. Silica fume at 15 wt % gives higher mean strength at two factor levels, 9 and 12 wt %, of Na₂CO₃ except at 6 wt %, where SF at 5 wt % gave a higher mean value. In fact, the 15 wt % of SF gives the lowest mean value at 6 wt % Na₂CO₃. This shows that there is a possibility of a significant interaction as the relationship between Na₂CO₃ and strength is dependent on the value of SF.

Evaluating the simple main effect of Na₂CO₃ by taking average of the square, diamond and star points at each factor level (line in FIG. 6) of Na₂CO₃ shows a large increase between 6 and 9 wt % but a very slight increase between 9 and 12 wt %, which is in correlation with the main effects plot in FIG. 4. The main effect of Na₂CO₃ is a possibility.

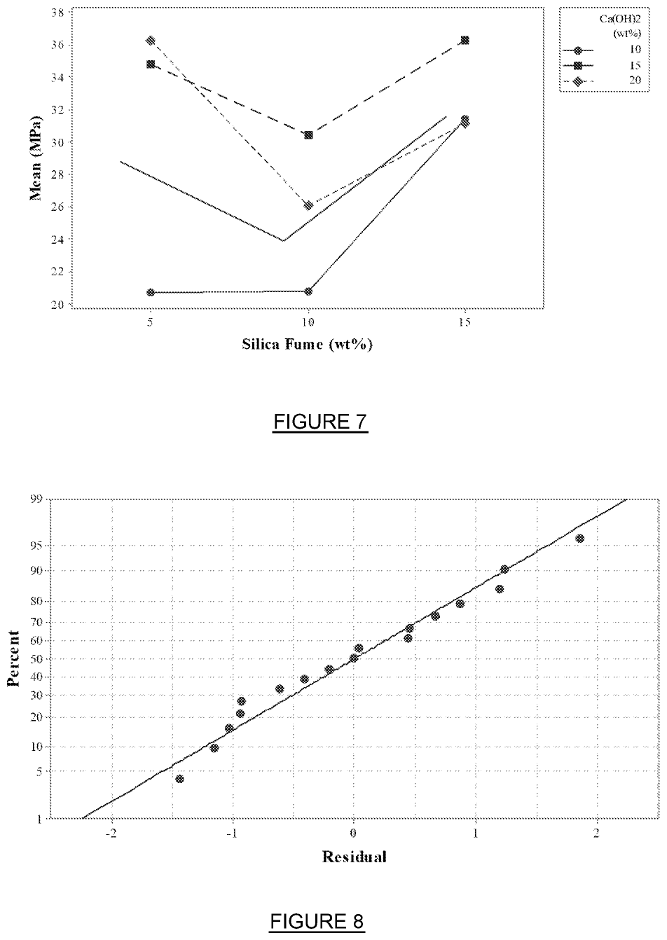

From FIG. 7, it can be again noticed parallel lines do not exist. Calcium hydroxide at 15 wt % gives higher mean strength at two factor levels, 10 and 15 wt %, of SF except at 5 wt %, where Ca(OH)₂ at 20 wt % gave a higher mean value. This shows that there is a possibility of a significant interaction as the relationship between SF and strength is dependent on the value of Ca(OH)₂. Calcium hydroxide at 10 wt % showed a lower mean value except at 15 wt % of SF where the mean value was similar to 20 wt % Ca(OH)₂ with 10 wt % Ca(OH)₂ being slightly higher. Moreover, it can be noticed that at 5 and 10 wt % SF factor levels for 10 wt % Ca(OH)₂, there was almost no change in the mean values.

Evaluating the simple main effect of SF by taking averages of the points at each factor level (line in FIG. 7) shows that it decreases between 5 and 10 wt % but increases between 10 and 15 wt %, which is in correlation with the main effects plot in FIG. 4. The main effect of SF is also another possibility.

The possible significance of the interactions and simple main effects will be checked via analysis of variance (ANOVA).

The analysis of variance (ANOVA) was computed first to test the adequacy of the model as shown in Table 8.

TABLE 7
Initial full quadratic model ANOVA result

| Source | DF | Adj SS | Adj MS | F-Value | P-Value |
|---|---|---|---|---|---|
| Model | 9 | 970.647 | 107.850 | 52.41 | <0.0001 |
| Linear | 3 | 303.355 | 101.118 | 49.14 | <0.0001 |
| Na₂CO₃ | 1 | 158.484 | 158.484 | 77.02 | <0.0001 |
| Ca(OH)₂ | 1 | 129.096 | 129.096 | 62.74 | <0.0001 |
| Silica Fume | 1 | 15.775 | 15.775 | 7.67 | 0.028 |
| Square | 3 | 148.133 | 49.378 | 24.00 | <0.0001 |
| Na₂CO₃*Na₂CO₃ | 1 | 0.443 | 0.443 | 0.22 | 0.657 |
| Ca(OH)₂*Ca(OH)₂ | 1 | 101.561 | 101.561 | 49.35 | <0.0001 |
| Silica Fume*Silica Fume | 1 | 95.432 | 95.432 | 46.38 | <0.0001 |
| 2-Way Interaction | 3 | 519.158 | 173.053 | 84.10 | <0.0001 |
| Na₂CO₃*Ca(OH)₂ | 1 | 263.122 | 263.122 | 127.87 | <0.0001 |
| Na₂CO₃*Silica Fume | 1 | 131.058 | 131.058 | 63.69 | <0.0001 |
| Ca(OH)₂*Silica Fume | 1 | 124.978 | 124.978 | 60.73 | <0.0001 |
| Error | 7 | 14.404 | 2.058 | | |
| Lack-of-Fit | 5 | 12.590 | 2.518 | 2.78 | 0.286 |
| Pure Error | 2 | 1.815 | 0.907 | | |
| Total | 16 | 985.051 | | | |

As seen from Table 7, the F-value of the model is 52.41 implying that the model is significant and the probability that this value was due to noise is less than 0.01%. Furthermore, the lack-of-fit P-value is 0.286 which indicates that it is insignificant as p>0.05. The insignificance of the lack-of-fit implies that the model fits the experimental data and the factors under consideration have a considerable impact on the response. However, it can be noticed that there is an insignificant term in the model (Na₂CO₃*Na₂CO₃). This was removed and the reduced model ANOVA results are shown in Table 8.

TABLE 8
Reduced model ANOVA result

| Source | DF | Adj SS | Adj MS | F-Value | P-Value |
|---|---|---|---|---|---|
| Model | 8 | 970.203 | 121.275 | 65.34 | <0.0001 |
| Linear | 3 | 303.355 | 101.118 | 54.48 | <0.0001 |
| Na₂CO₃ | 1 | 158.484 | 158.484 | 85.39 | <0.0001 |
| Ca(OH)₂ | 1 | 129.096 | 129.096 | 69.56 | <0.0001 |
| Silica Fume | 1 | 15.775 | 15.775 | 8.50 | 0.019 |
| Square | 2 | 147.690 | 73.845 | 39.79 | <0.0001 |
| Ca(OH)₂*Ca(OH)₂ | 1 | 120.013 | 120.013 | 64.66 | <0.0001 |
| Silica Fume*Silica Fume | 1 | 102.938 | 102.938 | 55.46 | <0.0001 |
| 2-Way Interaction | 3 | 519.158 | 173.053 | 93.24 | <0.0001 |
| Na₂CO₃*Ca(OH)₂ | 1 | 263.122 | 263.122 | 141.77 | <0.0001 |
| Na₂CO₃*Silica Fume | 1 | 131.058 | 131.058 | 70.61 | <0.0001 |
| Ca(OH)₂*Silica Fume | 1 | 124.978 | 124.978 | 67.34 | <0.0001 |
| Error | 8 | 14.848 | 1.856 | | |
| Lack-of-Fit | 6 | 13.033 | 2.172 | 2.39 | 0.324 |
| Pure Error | 2 | 1.815 | 0.907 | | |
| Total | 16 | 985.051 | | | |

The reduced model has a F-value of 65.34 which is greater than the initial model and still implies the model is significant. Moreover, the lack-of-fit is still insignificant (p=0.324>0.05) which again shows the adequacy of the model. Table 9 gives a comparison of the summary statistics for ANOVA of the initial model vs. reduced model.

TABLE 9
Summary statistic comparison between initial and reduced model

| | | | |
|---|---|---|---|
| S | R-sq | R-sq(adj) | R-sq(pred) |

Initial Model

| | | | |
|---|---|---|---|
| 1.43450 | 98.54% | 96.66% | 86.27% |

Reduced Model

| | | | |
|---|---|---|---|
| 1.36235 | 98.49% | 96.99% | 88.12% |

The R² of the reduced model indicates it can explain 98.49% of the model's variability. A large R² is usually a good indicator of the model's fit. However, the value of R² can be artificial increased as more predictors get included in the model without any real improvement to the system. Hence it is beneficial to compare the adjusted R² to the original R². The adjusted R² is a modified version of the normal R² and will only increase if the new term improves the model, if it has a strong correlation to the response. It decreases when the predictor does not have a strong correlation to the response. The adjust R² will always be less than R². From Table 9, the adjusted R² is 96.99% which is relatively high and further emphasises the model's adequacy and that non-significant terms have not been included.

The predicted R² is used, in conjunction with the adjusted R², to determine if there are too many predictors in the model and if it has been over-fit and is modelling random noise. An over-fit model will usually have a high R² value and low predicted R². From Table 9, the predicted R² is 88.12% which shows the models high predictive capability and confirms that the model has not been over-fit. It is also within the acceptable margin of 0.2 from the adjusted R².

To further confirm the adequacy of the model, it is required to assess the residual plots. A residual is the difference between the observed value and its fitted value. Analysis of residual plots assists in confirming the assumption that the errors are approximately normally distributed with constant variance and whether additional terms would need to be added to the model (Montgomery, 2011).

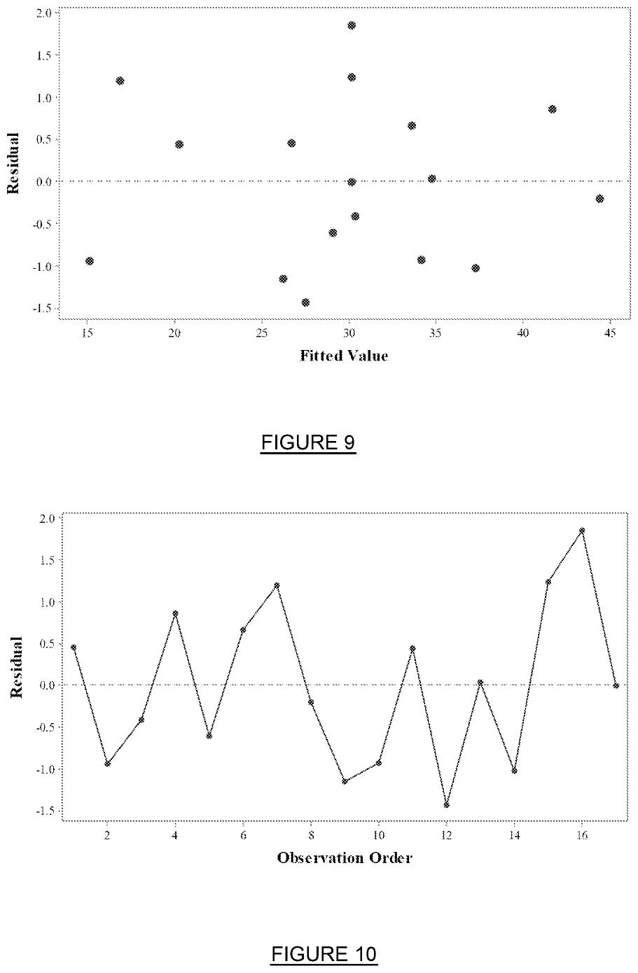

The graph in FIG. 9 represents the normal probability plot. Probability plots are used to assess whether the model has a fixed distribution. Most models are in the form,

Response=deterministic+stochastic

where the deterministic part is the fit and stochastic part is the error. The error part is most commonly assumed to be normally distributed. Therefore, a graph of a normal probability plot is generated from the residuals of the fitted model. FIG. 8 shows that the residuals follow a straight line, which verifies the assumption that the residuals are normally distributed.

The graph in FIG. 9 shows the residuals versus fits graph, which aids in confirming the assumption that the residuals constant variance and a mean of zero. As noticed, there are no visible trends in FIG. 9 as the plots are scattered randomly around zero so the assumption that errors have a mean of zero is valid. Furthermore, there are no visible trends in and the vertical width of the scatter does not change significantly when moving along the fitted values, which shows that the assumption of residuals having a constant variance to be reasonable.

Another assumption required to be validated is where the errors are said to independent of each other. A plot of residual vs. order plot is required to validate this assumption, which is a plot of the residuals versus the order in which the data was collected. This is shown in FIG. 10 for the model. For the assumption to hold true, it is required that the plots fluctuate randomly across the centreline of the graph, which is observed in FIG. 10 showing the residuals are uncorrelated and the model is adequate.

With the model statistics and assumptions satisfied after analysis of the residuals, the final model can be used to navigate the design space.

The final empirical model equation is given in Eq. 9 and Eq. 10 as coded and actual units, respectively. Coded variables help with interpretation of the model and variable effects as the magnitude of the coefficients are given on a common scale.

Y=30.200+3.981·A+3.593·B+1.256·C−6.295·B²+5.830·C²+5.735·A·B+4.047·A C−3.952·B·C (3)

where,

Y—Compressive strength (MPa)

A—Na₂CO₃ (wt %), −1≤A≤1

B—Ca(OH)₂ (wt %), −1≤B≤1

C—Silica Fume (wt %), −1≤C≤1

Y=23.82−7.106·A+6.41·B−4.471·C−0.2518·B²+0.2332·C²+0.3829·A·B+0.2698·A·C−0.1581·B·C (4)

where,

Y—Compressive strength (MPa)

A—Na₂CO₃ (wt %), 6≤A≤12

B—Ca(OH)₂ (wt %), 10≤B≤20

C—Silica Fume (wt %), 5≤C≤15

1.4.2. Compressive Strength

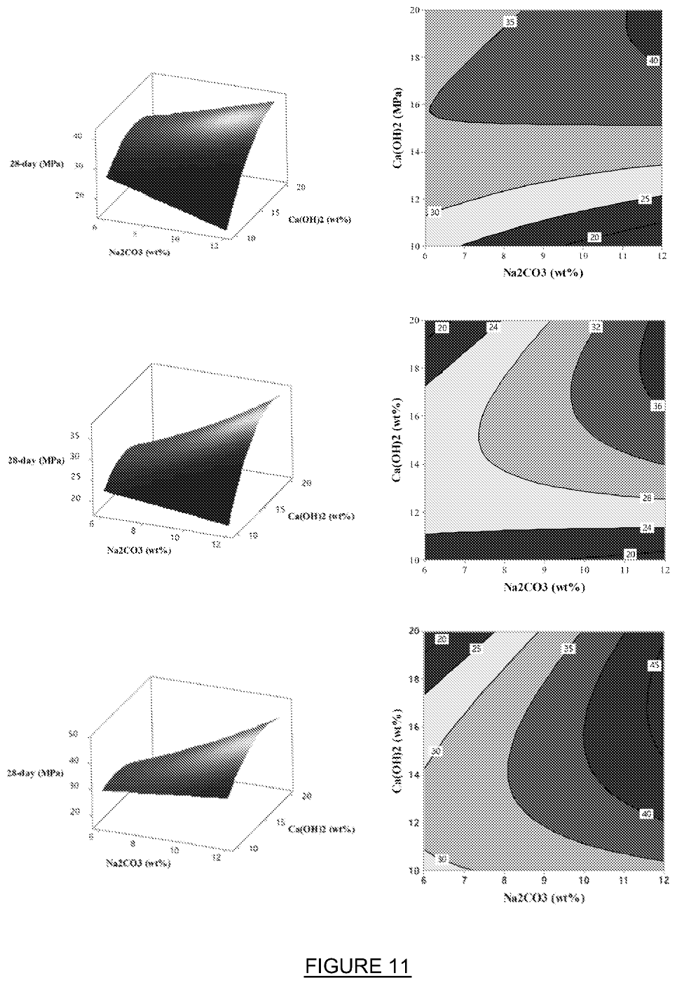

The surface and contour plots are given in FIG. 11. The general trend noticed from the compressive strength values was that when the strength was high at 3 days, it only increased by a small factor at 28 days. For examples, Mix SC6|CH20|S5, gained 9.81 MPa at 3 days and 29.9 MPa at 28 days. The opposite was true for other samples. The highest strength mix, SC12|CH20|SF15 gained 1.65 MPa at 3 days and ended with 44.2 MPa at 28 days. In general, samples that contained the lowest amount of Na₂CO₃ were responsible for the first trend regardless of the level of Ca(OH)₂ and SF.

The first trend of high early strength is in correlation with Jeon et al. (2015) where the author's samples gained considerable strength at 3 days (28 MPa) but did not develop as aggressively and only increased in strength by 29% at 28 days (36 MPa). The second trend was noticed by other authors (Abdalqader et al., 2016; Wang et al., 1994; Fernández-Jiménezet al., 1999; Li and Sun, 2000) and that is due to the lower pH of Na₂CO₃. It can demonstrate a lower strength in the beginning but a higher strength at later stages due to the effect of CO₃²⁻ ions, which causes the formation of carbonated compounds that improves mechanical strength.

Huang and Cheng (1986) mentions that in a FA-Ca(OH)₂—H₂O system, the hydration rate is low. The system's hydration rate increased by 1.5% in 7 days and was less than 20% after 180 days. The reasoning stated was that unlike slag, FA has a lower content of CaO; higher aluminium and silicon content, which requires a higher degree of polymerization. Thus, the hydration activation is much less than that of slag. Furthermore, in a system of FA-Ca(OH)₂, the pH is less than 13. Fraay and Bejen (1989) demonstrated that a pH value of 13.3 is required for appropriate dissolution of alumina and silica species. Therefore, it is required that other additives be added to the system to increase the alkalinity (Li et al., 2000).

Sodium carbonate, Na₂CO₃, compared to other conventional activators such as NaOH and Na₂SiO₃ has a lower pH. Thus Na₂CO₃, having a pH of 12.5, does not contain sufficient dissolution power in a FA based system.

However, by combining Na₂CO₃ with Ca(OH)₂ the following chemical balanced equation is formed:

Na₂CO₃+Ca(OH)₂→2NaOH_{(aq)}+CaCO₃ (5)

From Equation 11 it can be noticed there is formation of NaOH which increases the alkalinity of the mixture, although not a dominant factor, which promotes dissolution of the silica and alumina species in the FA. Furthermore, the CaCO₃ can act as filler material to reduce porosity and promote higher mechanical strength. However, considering the Gibbs energy of the chemical equation, it can be argued that such a reaction does not occur under ambient conditions. But the complexity of the system could cause the reaction to occur or other reactions due to the inclusion of SF which has a high reactivity due to its surface area. Jeon et al. (2015) had a similar blend (FA+Ca(OH)₂+Na₂CO₃) but was cured thermally at 60° C., which attained 36 MPa at 28-days. The highest strength sample in this study attained 44.2 MPa at 28 days under ambient conditions.

Samples that contained a higher content of sodium carbonate had a higher 28-day strength value than those with a lower content. This improvement could be explained by the fact that Na₂O content increases which increases the pH. An increased pH aids in the dissolution of the silicon and alumina species, which is responsible for strength development due to increased gel formation in the samples (Wang et al, 1994; Li and Sun, 2000). Overall both Na₂CO₃ and Ca(OH)₂ and their interaction (line in FIG. 5) had a positive impact on the mechanical strength.

Silica fume, on the other hand, had a positive and negative impact on the mechanical strength depending on the quantity. Silica fume's interaction with Na₂CO₃ was overall positive (line FIG. 6). However, the interaction with Ca(OH)₂ is unusual whereby there is a switch in effect from negative to positive with increasing SF quantity. Generally, the particles of SF are spherical and very fine. This implies it has a large surface area and reacts very readily with alkaline solution in a polymerisation reaction. Improved strength is noticeable due to the packing effect of fine SF that acts as a filler material for voids. This creates a more compact microstructure. Furthermore, they also act as nucleation sites for alkali reactions and thus will promote the formation of alkali-activated products (Nurrudin et al., 2010; Rashad & Khalil, 2013; Sayed & Zedan, 2013; Songpiriyakij et al., 2011). This was found to be true for most of the mixes. Samples containing larger quantities of SF produced higher mechanical strength.

The following sections deal with the characterization techniques used to evaluate the microstructural and mineralogical changes over time for selected samples at 3 and 28 days. The selected samples were SC12|CH20|SF5, SC12|CH10|SF5 and SC6|CH20|SF5, which gained high strength, low strength and moderate strength, respectively.

1.4.3. X-Ray Diffraction (XRD) Analysis

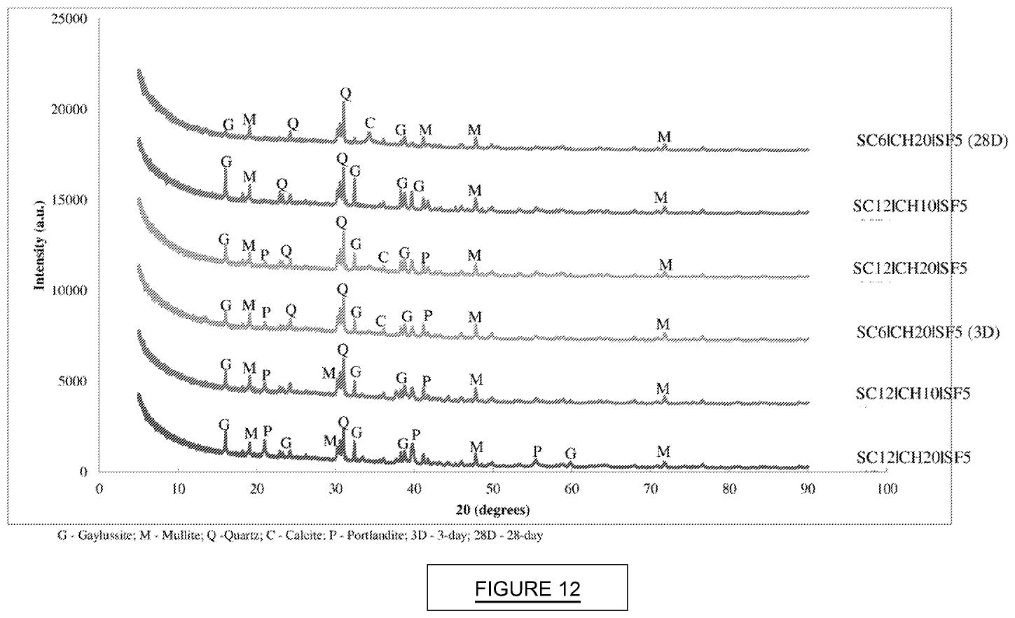

The graph in FIG. 12 represents the diffractograms for samples SC12|CH20|SF5, SC12|CH10|SF5 and SC6|CH20|SF5 at 3 and 28 days.

Fly ash consists of stable but un-reactive crystalline phases such as mullite and quartz as well as reactive amorphous phases. Therefore, during reaction, the reactive part undergoes alkali activation whilst the un-reactive phases act as micro-aggregate in the final matrix (Kumar et al. 2017; Duxson et al. 2005). The major peak at approximately 31° is due to quartz that was present in the fly ash.

Portlandite, which is calcium hydroxide, gets consumed and lower amounts are present at 28 days as seen in the XRD results. Sample SC12|CH20|SF5 at 3 days (FIG. 12) the peaks at 21° and 40° represent portlandite and it can be observed that the intensity of the peaks at 28 days is lower than at 3 days, showing the full consumption has not completed. Moreover, for mix SC12|CH10|SF5 and SC6|CH20|SF5 the portlandite peaks, occurring at the same position, occurs in the 3-day samples but disappear completely in the 28-day samples.

Walkley et al. (2016) suggests that increasing the calcium content in precursors enables greater formation of low-Al, high Ca containing C-(N)-A-S-H with lower mean chain length (MCL) and AFm type phases with little evolution of binder chemistry at later stage. Authors mention that in general, increasing the Ca content in precursors impedes the formation of N-A-S-H and AFm type phases and in Al-rich samples, promotes the formation of portlandite and Al-rich reaction products. However, the diffractograms did not show any zeolitic formation and the hydration product for this type of binder system is most likely to be a C-S-H variant.

As the peaks of portlandite decrease/disappear with increasing age, there is progressive consumption which can be facilitated by lime-consuming C-S-H formation and also due to the available silicon in the reaction mixtures, forming additional gels (Jeon et al. 2015). The increase in calcite amount over the time period can also decrease the amount of portlandite due to carbonation. This is proven by the calcite peaks noticed in the 28-day samples in sample SC12|CH20|SF5 and SC6|CH20|SF5 at position 34° in both diffractograms. In sample SC12|CH10|SF5 there was no calcite reflection at 28-day but the portlandite reflection at 3-day completely disappears, which can be most likely attributed to its consumption and formation of C-S-H type gels.

Carbonate salt gaylussite, sodium-calcium carbonate, was identified in the samples which indicate cation exchange reaction between the precursor and activator. In the alkali-activation, the Ca²⁺ ions provided by calcium hydroxide must react with the CO₃²⁻ from sodium carbonate to form carbonate salts such as calcite and gaylussite (Eq. 6) such that the pH can be increased through the release of OH⁻ ions. After gels start to precipitate, the gaylussite dissolves as a result of decreasing concentration of gaylussite CO ions in the aqueous phase. The carbonate then re-precipitates as CaCO₃ polymorphs such as calcite. Thus, gaylussite is a transient phase that decreases/get consumed as more stable carbonates form at later stages as shown in Eq. 7 (Ke et al., 2016; Yuan et al., 2017; Bernal et al., 2014). This is in correlation with the XRD patterns in FIG. 12. There is a notable decrease in peak intensity from 3 to 28 days for all samples and in the case of SC12|CH20|SF5 and SC6|CH20|SF5, there is formation of calcite. Calcite acts as an inactive filler material and do not contribute to the formation of the gel structure (Aboulayt et al., 2017).

5H₂O+2Na⁺+Ca²⁺+2CO₃²⁻→Na₂Ca(CO₃)₂.5H₂O(gaylussite) (6)

Na₂Ca(CO₃)₂.5H₂O→CaCO₃+2Na⁺+CO₃²⁻+5H₂O (7)

In conclusion, the mechanism noticed is the formation of large quantity of gaylussite for all samples which transforms into carbonate phases at later age, noticed by the lower gaylussite peaks and formation of calcite peaks. The portlandite consumption can be tied to the formation of C—S—H type gels. This consumption followed by calcite formation can explain the difference in strength noticed for the three samples. For the high strength sample (SC12|CH20|SF5), portlandite peak intensity was the highest when compared to the other two. Furthermore, unlike the other two samples, portlandite peaks still remained at 28 days showing that more gels could form and the sample can gain more strength. Furthermore, for SC6|CH20|SF5, calcite formation was occurring already at 3rd day and its peak intensity increased at 28 day. This shows the gaylussite transformation was occurring much earlier on when compared to SC12|CH20|SF5 and SC12|CH10|SF5.

1.4.4. SEM Analysis

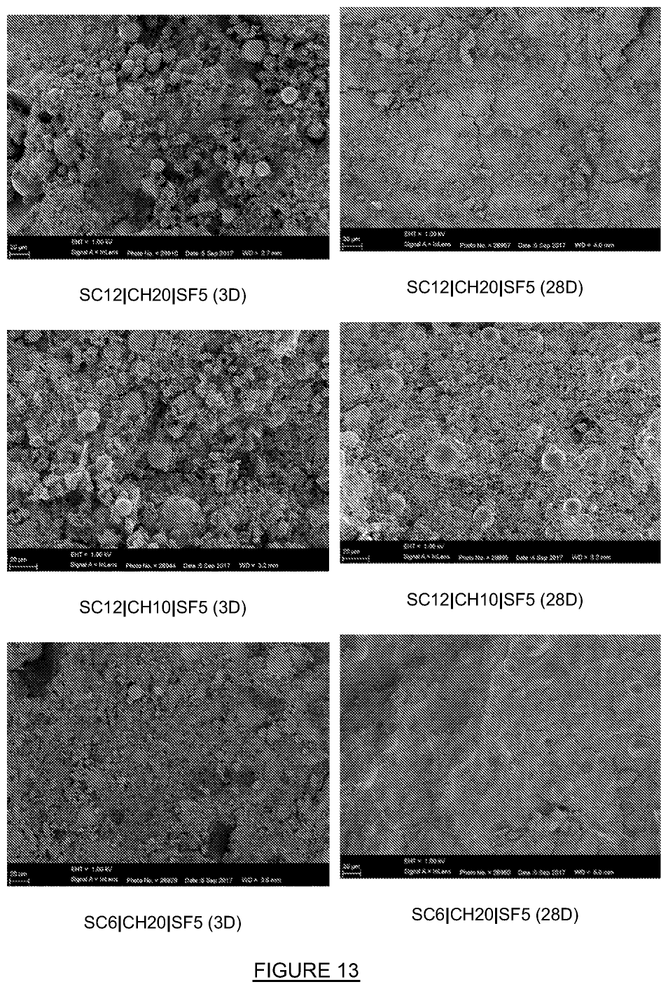

One of the main trends noticed in the experiment was that samples that gained higher strength at 28-day had lower strengths at early age. The opposite occurred for samples that gained lower strengths at 28-day. FIG. 13 shows SEM samples of SC12|CH20|SF5, SC12|CH10|SF5 and SC6|CH20|SF5, at different curing ages, to further understand the noticed trend.

For the samples at 3-day, it can already be noticed that there is a large disparity in the amount of unreacted particles. Mix SC12|CH20|SF5, which gained the second highest strength at 28 days but low 3-day strength, has a noticeable amount of unreacted FA and SF particles as well as sodium carbonate crystals. Mix SC12|CH10|SF5, which gained the lowest 28-day strength, showed similar characteristics to the sample SC12|CH20|SF5 SEM image but the amount of unreacted particles were more prominent. However, mix SC6|CH20|SF5, which had one of the highest 3-day strength of all the samples, showed a significantly lower amount of unreacted particles, comparatively. The SEM image of SC6|CH20|SF5 (3D) shows a more developed microstructure with large amorphous area at early age compared to the other two, which can explain the higher strength at 3-day.

Investigating the 28-day samples, SC12|CH20|SF5 had scarce amount of unreacted particles and mostly consisted of a dense amorphous microstructure. This shows that most of the unreacted particles noticed in the 3-day samples had reacted and could be the reasoning behind on why it gained high strength. Mix SC12|CH10|SF5 which had similar characteristic to mix SC12|CH20|SF5 at 3-day did not, however, show a similar trend. There is still copious amounts of unreacted FA and SF particles as well as sodium carbonate crystals. Sample SC6|CH20|SF5 showed the same characteristic as its 3-day counterpart but contained a larger quantity and size of unreacted particles when compared to mix SC12|CH20|SF5. This shows that it did not undergo a large dissolution phase unlike sample SC12|CH20|SF5, which caused the strength value to be lower in comparison.

Comparing the microstructure of mix SC12|CH20|SF5 between 3-day and 28-day, it can be noticed the porosity of sample decreased over time. This can be attributed to the formation of calcite and its formation noticed in the XRD diffractograms. This confirms the theory that calcite acts a pore-filling material as mentioned earlier. Similar trend is noticed in the other two samples but the porosity is slightly higher. Moreover, the reduction in porosity can be also be attributed to the inclusion of SF. The particles of SF are spherical and very fine. This implies it has a large surface area and reacts very readily. Improved strength is noticeable due to the packing effect of fine and spherical SF that acts as a filler material for voids. This creates a more compact microstructure. Furthermore, they also act as nucleation sites for reactions and thus will promote the formation of amorphous gels (Nurrudin et al., 2010; Rashad & Khalil, 2013; Sayed & Zedan, 2013; Songpiriyakij et al., 2011).

Moreover, since no additional adjustments were made to accommodate the increase in SF content, the samples were prone to excessive self-desiccation and cracking due to its large surface area (Khater, 2013; De Silva et al., 2007). Rashad and Khalil (2013) observed similar scenario where a 5% SF replacement created a denser and more homogenous microstructure and had the highest strength. However, with increasing SF, the microstructure deteriorated and caused lower mechanical strength but was still better than with no SF inclusion. Aydin (2013) also had a similar situation where a 20 wt % SF replacement caused a porous structure with disconnected pores. Thus, it can be said that SF could prove to be detrimental at higher levels but beneficial at lower levels.

In conclusion, the SEM analysis correlated well with the XRD data. The moderate strength sample SC6|CH20|SF5 at 3-day had a lower amount of unreacted particles and a more homogenous microstructure, which can be attributed to the gaylussite transformation into carbonate species as it was the only sample to show calcite peaks at 3-day. This could also imply gel formation took place earlier and it did not gain additional strength unlike SC12|CH20|SF5. SC12|CH20|SF5 gained higher strength due to the denser microstructure at 28-day and this can be connected to the largest portlandite peaks noticed at 3- and 28-day in the XRD data for this sample. SC12|CH6|SF5 still had unreacted after 28-days showing full dissolution had not taken place or was taking place at a slow pace. It was also the most porous sample which can again be tied to no calcite peaks noticed in the XRD data at 28-day in FIG. 12.

1.4.5. FTIR Analysis

Fourier transform infrared spectroscopy (FTIR) enables interpretation of the degree of polymerization of the reaction products and making conclusions about the types of structures present. The vibration of molecular bonds will differ depending on the absorption of photons at appropriate energies. Thus, this allows relating structures to the energy that is absorbed and define the functional groups of the product. Molecular bonds will exhibit narrow peaks if the structure is highly crystalline. If the structure is amorphous, the IR spectra will show wider/broader bands/peaks (Dakhane et al., 2017).

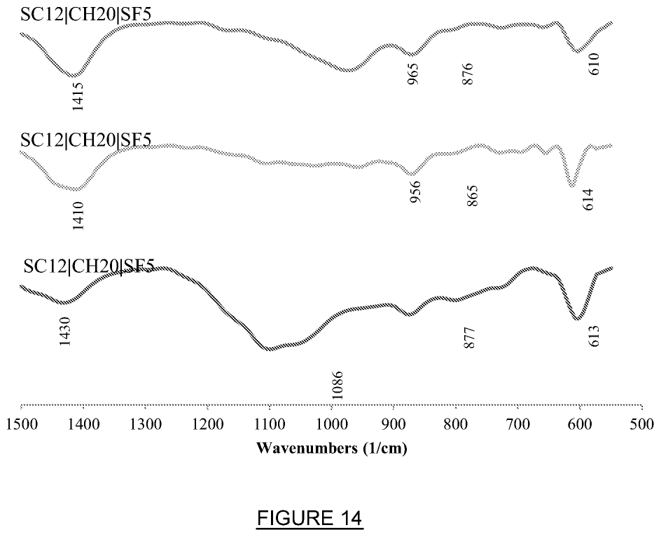

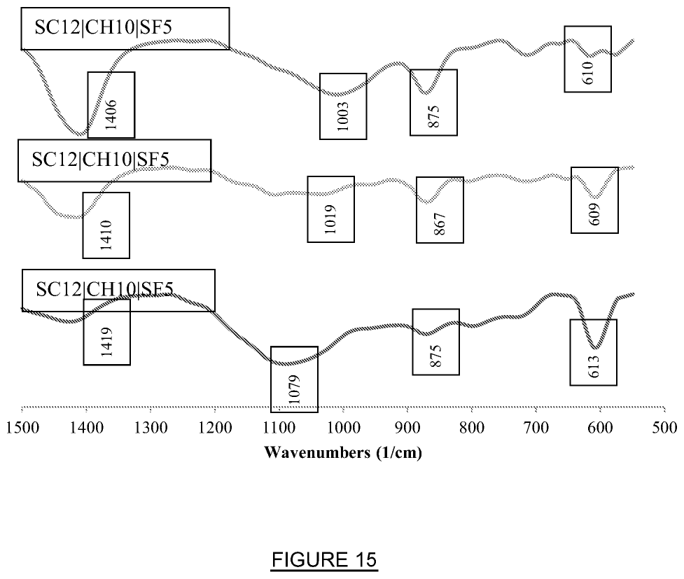

FIGS. 14, 15 and 16 represent the IR spectrum from wavelength section 1500 to 500 cm⁻¹ of SC12|CH20|SF5, SC12|CH10|SF5 and SC6|CH20|SF5 for raw blended materials and at different ages, respectively. There were not any noticeable changes from 4000 to 1500 cm⁻¹ and thus not included in the Figures, except some minor broad humps noticed in the region of 3600 to 3500 cm⁻¹, which can be attributed to the strength vibration of —OH (Jang & Lee, 2016). There is a significant peak occurring in the region 1440 to 1410 cm⁻¹ in all samples as well as a smaller peak around 880 to 865 cm⁻¹ region. This can be associated with stretching vibrations of C═O or CO₃²⁻ anions, which confirms the formation of carbonate species (Peyne et al., 2017; Kumar et al., 2017; Lee et al., 2017; Abdel-Gawwad & Abo-El-Enein., 2014). The absorbance peaks at these two wavelengths indicate the formation of calcite and with increasing age, the intensity of the peaks increase.

Noticing the IR spectra of the raw blended mix for all samples, there is an absorbance band around 1080 cm⁻¹ wavelength. This is attributed to asymmetric stretching vibration mode of Si—O-T (T=tetrahedral Si or Al) caused by the presence of FA in the blended mixture. For all investigated samples, this main band shifted to a lower wavelength with increasing age. This is known to be a common occurrence in FA based activated materials as it represents the extent of the reaction/formation of gels due to the effect of activators on the original material, fly ash (de Vargas et al., 2014; Jang and Lee, 2016; Siyal et al., 2016).

For SC12|CH20|SF5 the main band in the blended mix appears at 1086 cm⁻¹ and shifted to 954.7 cm⁻¹ at 3-day and then to 965.4 cm⁻¹ at 28-day (FIG. 14). The initial shift to a lower frequency indicates the formation of Al-rich gel but the slight shift to a higher wavelength at a later stage indicates the transformation of the gel into a Si-rich gel. The shift to a lower wavelength is due to the reduced calcium content in the gel due to the incorporation of Al due to the dissolution of FA in the mixture. This shift indicates the material with beneficial mechanical properties (Jang and Lee, 2016; Criado et al., 2012; Abdalqader et al., 2015). Moreover, Garcia-Lodeiro et al. (2011) suggest that bands in the 950-970 cm⁻¹ region represent C-S-H and C-A-S-H type gels whilst bands in the 1000 cm⁻¹ represent N-A-S-H gel.

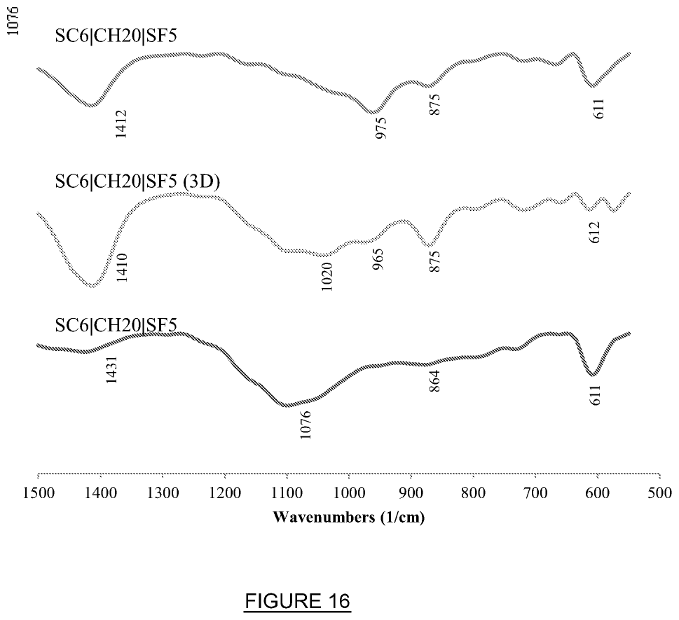

Therefore, for SC12|CH20|SF5, the reversal in band to a higher wavelength is noticed and is in the range of 950 to 970 cm⁻¹ which implies it may have a C-A-S-H type gel. Similarly, for SC6|CH20|SF5, the main band appeared at 1076 cm⁻¹ and moved to 965.6 cm⁻¹ at 3-day and then to 975.2 cm⁻¹ at 28-day (FIG. 16). The final wavelength position for SC6|CH20|SF5 is higher than that for SC12|CH20|SF5 (965.4 cm⁻¹ vs. 975.2 cm⁻¹) which could be a possible reason for the higher strength gain in SC12|CH20|SF5 than SC6|CH20|SF5 at 28-day. The closer the wavelength is to 950 cm⁻¹, the gel gets most commonly attributed to C-S-H which gives better mechanical strength (Dakhane et al., 2017). This is evident in the higher amorphous nature of the microstructure as noticed in SEM/EDS analysis discussed herein above.

For SC12|CH10|SF5, the main band appeared at frequency 1079 cm⁻¹ which shifted to 1019 cm⁻¹ at 3-day but then moved to a lower 1003 cm⁻¹ at 28-day (FIG. 16). Therefore this represents a possible N-A-S-H or N-(C)-A-S-H type gels which can contribute to its lower mechanical strength. It also implies that the polymerization reaction is still continuous and when it completes, the band should move towards a higher wavelength (Siyal et al., 2016).

The series of small bands appearing around 790 cm⁻¹ and 660 cm⁻¹ can be attributed to symmetric stretching of O—Si—O bonds and the strong peaks appearing around 560 cm⁻¹ can be associated with symmetric stretching of Al—O—Si bonds. This is related to the presence of quartz and mullite from the raw fly ash in the raw blended samples (Jang and Lee, 2016).

### Discussion

The present invention considers trying to eliminate the use NaOH, which is caustic in nature. The process of producing alkali-activated binders has its drawbacks that prevent the process from being accepted in the industry: the use of highly alkaline activators like NaOH and Na₂SiO₃ to attain alkali activation possess problems pertaining to handling and storage (Dakhane, et al., 2017).

The novel composition of the present invention uses a low impact activator sodium carbonate (Na₂CO₃) and hydrated lime (Ca(OH)₂). Sodium carbonate is a naturally occurring mineral and can be obtained from sodium carbonate-rich brines or chemical processes such as the Solvay process. The worldwide total of natural occurring sodium carbonate amounts to 24 billion tonnes (USGS, 2017). Moreover, Na₂CO₃ is reported to be 2-3 times cheaper than NaOH or sodium silicate. In addition to the low cost of this activator compared to conventional ones, it is safer to handle and has been reported to yield lower drying shrinkage. Thus, the use of Na₂CO₃ as an activator can contribute to the development of more sustainable AAMs (Abdalqader et al., 2016).

The efflorescence formation of the FA-SF blend reacted with Ca(OH)₂ and Na₂CO₃ (FA|SF|CH|SC) was little to none. The FA|SF|CH|SC blend, produces a dry AAM cement powder that can be mixed together and stored in bags just like OPC cement bags.

The FA|SF|CH|SC blend gained a maximum strength of 44.2 MPa and lowest strength of 14.2 MPa at 28-day.

Sodium carbonate and Ca(OH)₂ were the main factors that positively affected the mechanical strength of the FA|SF|CH|SC blend with increasing content.

The main trend noticed in the FA|SF|CH|SC blend was that samples containing a lower quantity of Na₂CO₃ gained high strength at 3-day but did not undergo much reaction afterward. The opposite of this was also true. This shows Na₂CO₃ is required to react with Ca(OH)₂ to increase the pH of the system and help with the dissolution of the Si and Al precursors in the source materials.

XRD analysis shows crystalline phases of gaylussite and calcite in the FA|SF|CH|SC blend. Gaylussite is a transient phase that decreases/get consumed as more stable carbonates form at later stages.

Calcite acts as an inactive filler material and do not contribute to the formation of the gel structure. Samples that gained high strength at 3-day but did not undergo much reaction afterward was because of early reaction due to the lower Na₂CO₃ content. This causes a lower quantity of gel formation but an earlier reaction phase. Therefore, the gaylussite had a longer time to transform to its stable carbonate species, such as calcite, which enabled the mixes to gain better strength as seen by the characterization techniques.

In conclusion, the novel composition of the present invention proves to be a viable FA-based AAM system that provides a cost effective and efficient building material that can gain sufficient strength under ambient conditions. Furthermore, this type of blend can be created as a dry material that can be stored and distributed in bags and only requires the addition of water to form the building material.

Whilst only certain embodiments or examples of the instant invention have been shown in the above description, it will be readily understood by a person skilled in the art that other modifications and/or variations of the invention are possible. Such modifications and/or variations are therefore to be considered as following within the spirit and scope of the present invention as defined herein.

### REFERENCES

Abdalqader, A. F. Jin, F. & Al-Tabbaa, A. 2016, ‘Development of greener alkali-activated cement: utilisation of sodium carbonate for activating slag and fly ash mixtures’, Journal of Cleaner Production, vol 113, pp. 66-75.
Abdalqader, A. F. Jin, F. & Al-Tabbaa, A. 2015, ‘Characterisation of reactive magnesia and sodium carbonate-activated fly/slag paste blends’, Construction and Building Materials, vol 93, pp. 506-513.
Abdel-Gawwad, H. A. & Abo-El-Enein, S. A. 2016, ‘A novel method to produce dry geopolymer cement powder’, HBRC Journal, vol 12, pp. 13-24.
Aboulayt, A. Riahi, M. Touhami, M. O. Hannache, H. Gomina, M. &Moussa, R. 2017, ‘Properties of metakaolin based geopolymer incorporating calcium carbonate’, vol 28, pp. 2393-2401.
Aydin, S. 2013, ‘A ternary optimisation of mineral additives of alkali activated cement mortars’, Construction and Building Materials, no. 43, pp. 131-138.
Benhelal, E. Zahedi, G. Shamsaei, E.& Bahadori, A. 2013, ‘Global strategies and potentials to curb CO₂ emissions in cement industry’, Journal of Cleaner Production, no. 51, pp. 142-161.
Bernal, S. A. de Gutiérreza, R. M. Pedraza, A. L. Provis, J. L. Rodriguez, E. D.& Delvasto, S. 2011, ‘Effect of binder content on the performance of alkali-activated slag concretes’, Cement and Concrete Research, vol 41, no. 1, pp. 1-8.
Bernal, S. A. Provis, J. L. Myersm R. J. San Nicolas, R. & van Deventer, S. J. S. 2015, ‘Role of carbonates in the chemical evolution of sodium carbonate-activated slag binders’, Materials and Structures, vol 48, no. 2, pp. 517-529.
Chi, M. 2012, ‘Effects of dosage of alkali-activated solution and curing conditions on the properties and durability of alkali-activated slag concrete’, Construction and Building Materials, no. 37, pp. 240-245.
Chi, M.& Huang, R 2013, ‘Binding mechanism and properties of alkali-activated fly ash/slag mortars’, Construction and Building Materials, vol 40, pp. 291-298.
Criado, M. Fernandez-Jimenez, A. Sobrados, I. Palomo, A. & Sanz, J. 2012, ‘Effect of relative humidity on the reaction products of alkali activated fly ash’, Journal of the European Ceramic Society, vol 32, no. 11, pp. 2799-2807
Dakhane, A. Tweedley, S. Kailas, S. Marzke, R. & Neithalath, N. 2017, ‘Mechanical and microstructural characterization of alkali sulfate activated high volume fly ash binder’, Materials and Design, vol 122, pp. 236-246.
De Silva, P. Sagoe-Crenstil, K.& Sirivivatnanon, V. 2007, ‘Kinetics of geopolymerization: Role of Al₂O₃ and SiO₂’, Cement and Concrete Research, vol 37, no. 4, pp. 512-518.
Duxson, P. Provis, J. L. Lukey G. C. Mallicoat S. W. Kriven W. M. & van Deventer J. S. J. 2005, ‘Understanding the relationship between geopolymer composition, microstructure and mechanical properties’, Colloids and Surfaces A: Physicochemical and Engineering Aspects, vol 269, pp. 47-58.
Eskom 2014, Eskom Integrated Report 2014, viewed 15 Feb. 2015, <http://integratedreport.eskom.co.za/pdf/full-integrated.pdf>.
Fernandez-Jimenez, A. Palomo, J. G & Puertas, F. 1999, ‘Alkali-activated slag mortars mechanical strength behaviour’, Cement and Concrete Research, vol 29, pp. 1313-1321.
Fraay, A. L. A and Bejen, J. M. 1989, ‘The reaction of fly ash in concrete: A critical examination,’ Cement and Concrete Research, no. 19, pp. 235-246.
Gao, K. Lin, K-L. Wang, D. Hwang, C-L. Shiu, H-S. Chang, Y-M.& Cheng, T-W. 2014, ‘Effects SiO₂/Na₂O molar ratio on mechanical properties and the microstructure of nano-SiO₂ metakaolin-based geopolymers’, Construction and Building Materials, vol 53, no. 28, p. 2014.
Gao, T. Shen, L. Shen, M. Chen, F. Liu, L.& Gao, L. 2014, ‘Analysis on differences of carbon dioxide emission from cement production and their major determinants’, Journal of Cleaner Production, pp. 1-11.
Gao, X. Yu, Q. L.& Brouwers, H. J. H. 2015, ‘Reaction kinetics, gel character and strength of ambient temperature cured alkali activated slag—fly ash blends’, Construction and Building Materials, vol 80, pp. 105-115.
Garcia-Lodeiro, I. Palomo, A. Fernandez-Jimenez, A. & Macphee, D. E. 2011, ‘Compatibility studies between N-A-S-H and C-A-S-H gels. Study in the ternary diagram Na₂O—CaO—Al₂O₃—SiO₂—H₂O’, Cement and Concrete Research, vol 41, pp. 923-931.
Gibbs, M. J. Soyka, P.& Connely, D. 2000, ‘CO₂ emissions from cement production’, Good Practice Guidance and Uncertainty Management in National Greenhouse Gas Inventories, pp. 175-182.
Huang, S. & Cheng, J. 1986, ‘Kinetic of reaction in the system of fly ash-Ca(OH)₂—H₂O,’ The Journal of Chinese Ceramic Society, vol 14, no. 1, pp. 191-197.
IEA & WBSCD 2009, Cement Technology roadmap 2009: Carbon emissions reductions up to 2050, viewed 8 Jan. 2015, <http://www.wbcsdcement.org/pdf/technology/WBCSD-IEA_Cement %20Roadmap.pdf>.
Ismail, I. Bernal, S. A. Provis, J. L. Nicolas, R. S. Brice, D. G. Kilcullen, A. R. Hamdan, S.& van Deventer, J. S. J. 2013, ‘Influence of fly ash on the water and chloride permeability of alkali-activated slag mortars and concretes’, Construction and Building Materials, vol 48, pp. 1187-1201.
Jang, J. G. Lee, N. K.& Lee, H. K. 2014, ‘Fresh and hardened properties of alkali-activated fly ash/slag pastes with superplasticizers’, Construction and Building Materials, vol 50, pp. 169-176.
Jang, J. G. & Lee, H. K. 2016, ‘Effect of fly ash characteristics on delayed high-strength development of geopolymers’, Construction and Building Materials, vol 102, pp. 260-269.
Jeon, D. Jun, Y. Jeong, Y. & Oh J. E. 2015, ‘Microstructural and strength improvements through the use of Na₂CO₃ in a cementless Ca(OH)₂-activated Class F fly ash system’, Cement and Concrete Research, vol 67, pp. 215-225.
Khater, H. M. 2013, ‘Effect of silica fume on the characterization of the geopolymer materials’, International Journal of Advanced Structural Engineering, vol 5, no. 12.
Kim, E. H. 2012, ‘Understanding effects of silicon/aluminum ratio and calcium hydroxide on chemical composition, nanostructure and compressive strength for metakaolin geopolymers’, Thesis, University of Illinois at Urbana-Champaign, Ill.
Kumar, S. Mucsi, G Kristaly, F. & Pekker, P. 2017, ‘Mechanical activation of fly ash and its influence on mixro and nano-structural behaviour of resulting geopolymers’, Advanced Powder Technology, vol 28, pp. 805-813.
Lee, N. K.& Lee, H. K. 2013, ‘Setting and mechanical properties of alkali-activated fly ash/slag concrete manufactured at room temperature’, Construction and Building Materials, vol 47, pp. 1201-1209.
Lee, W. K. W. & Van Deventer, J. S. J. 2002, ‘The effects of inorganic salt contamination on the strength and durability of geopolymers’, Colloids and Surfaces A: Physiochemical and Engineering Aspects, vol 211, no. 2-3, pp. 115-126.
Lee, N. K. Koh, K. T. Kim, M.O. An, G. H. & Ryu, G. S. 2017, ‘Physicochemical changes caused by reactive MgO in alkali-activated fly ash/slag blends under accelerated carbonation’, Ceramics International, vol 43, pp. 12490-12496.
Lee, B. Kim, G. Kim, R. Chom B. Lee, S. & Chon, C. M. 2017, ‘Strength development properties of geopolymer paste and mortar with respect to amorphous Si/AI ratio of fly ash’, Construction and Building Materials, vol 151, pp. 512-519.
Madlool, N. A. Saidur, R. Hossain, M. S.& Rahim, N. A. 2011, ‘A critical review on energy use and savings in the cement industries’, Renewable and Sustainable Energy Reviews, no. 15, pp. 2042-2060.
Montgomery, D. C. 2011. Applied Statistics and Probability for Engineers. 5th Edition. John Wiley & Sons, Asia.
Part, W. K. Ramli, M. & Cheah, C. B. 2015, ‘An overview on the influence of various factors on the properties of geopolymer concrete derived from industrial by-products’, Construction and Building Materials, vol 77, pp. 370-395
Palomo, A. Grutzeck, M. W.& Blanco, M. T. 1999, ‘Alkali-activated fly ashes: A cement for the future’, Cement and Concrete Research, no. 29, pp. 1323-1329.
Peyne, J. Gautron, J. Doudeau, J. Joussein, E. & Rossignol, S. 2017, ‘Influence of calcium addition on calcined brick clay based geopolymers: A thermal and FTIR spectroscopy study’, Construction and Building Materials, vol 152, pp. 794-803.
PPC 2017, PPC Integrated Report 2017, viewed 15 Aug. 2017, <http://www.ppc-reports.co.za/iar-2017/pdf/full.pdf>.
Provis, J. L.& Bernal, S. A. 2014, ‘Geopolymers and Related Alkali-Activated Materials’, Annual Reviews.
Rashad, A. M. 2013, ‘A comprehensive overview about the influence of different additives on the properties of alkali-activated slag—A guide for Civil Engineer’, Construction and Building Materials, no. 47, pp. 29-55.
Rashad, A. M. Bai, Y. Basheer B. A. M. Milestone, N. B. & Collier N. C. 2013, ‘Hydration and properties of sodium sulfate activated slag’, Cement and Concrete Composites, vol 37, pp. 20-29.
Rashad, A. M. 2014, ‘A comprehensive overview about the influence of different admixtures and additives on the properties of alkali-activated fly ash’, Materials and Design, no. 53, pp. 1005-1025.
Rashad, A. M.& Khalil, M. H. 2013, ‘A preliminary study of alkali-activated slag blended with silica fume under the effect of thermal loads and thermal shock cycles’, Construction and Building Materials, vol 40, pp. 522-532.
Reig, L. Soriano, L. Borrachero, M. V. Monzo J. & Paya J. 2016, ‘Influence of calcium aluminate cement (CAC) on alkaline activation of red clay brick waste (RCBW),’ Cement and Concrete Composites, vol 65, pp. 177-185
Reig, L. Sanz, M. A. Borrachero, M. V. Monzo, J. Soriano, L. & Paya, J. 2017, ‘Compressive strength and microstructure of alkali-activated mortars with high ceramic waste content’, Ceramics International, vol 43, pp. 13622-13634.
Reinard, J. C. 2006, ‘Factorial Analysis of Variance’, in Communication Research Statistics, SAGE Publications.
Ryu, G. S. Lee, Y. B. Koh, K. T.& Chung, Y. S. 2013, ‘The mechanical properties of fly ash-based geopolymer concrete with alkaline activators’, Construction and Building Materials, vol 47, pp. 409-418.
Ryu, G. S. Lee, Y. B. Koh, K. T.& Chung, Y. S. 2013, ‘The mechanical properties of fly ash-based geopolymer concrete with alkaline activators’, Construction and Building Materials, no. 47, pp. 409-418.
Sayed, M.& Zeedan, S. R. 2012, ‘Green binding material using alkali activated blast furnace slag with silica fume’, HBRC Journal, vol 8, no. 3, pp. 177-184.
Shi, C. & Day, R. L. 2000, ‘Pozzolanic reaction in the presence of chemical activators: Part I. reaction kinetics’, Cement and Concrete Research, vol 30, no. 1, pp. 51-58.
Shi, C. & Day, R. L. 2000, ‘Pozzolanic reaction in the presence of chemical activators: Part II. reaction products and mechanism’, Cement and Concrete Research, vol 30, pp. 607-613.
Silva, S. V. A. Arachchi, J. N. J. K. Wijewardena, C. L.& Nanayakkara, S. M. A. 2013. ‘Development of Fly Ash Based Geopolymer Concrete’, Experimental investigation, Department of Civil Engineering, University of Moratuwa.
Silva, P. D. Sagoe-Crenstil, K. and Sirivivatnanon, V. 2007, ‘Kinetics of geopolymerization: role of Al₂O₃ and SiO₂’, Cement Concrete Research, vol 37, no. 4, pp. 512-518.
Siyal, A. A. Azizli, K. A. Main, Z. Ismail, L. & Khan, M. I. 2016, ‘Geopolymerization kinetics of fly ash based geopolymers using JMAK model’, Ceramics International, vol 42, pp. 15575-15584.
Songpiriyakij, S. Pulngern, T. Pungpremtrakul, P.& Jaturapitakkul, C. 2011, ‘Anchorage of steel bars in concrete by geopolymer paste’, Materials and Design, vol 32, no. 5, pp. 3021-3028.
Stevens, J. J. 2000, Interactions Effects in Regression, viewed 13 May 2015, <http://pages.uoregon.edu/stevensj/interaction.pdf>.
Torgal, F. P. Gomes, J. C.& Jalali, S. 2008, ‘Alkali-activated binders: A review Part 1. Historical background, terminology, reaction mechanisms and hydration products’, Construction and Building Materials, no. 22, pp. 1305-1314.
Turner, L. K.& Collins, F. G. 2013, ‘Carbon dioxide equivalent (CO₂-e) emissions: A comparison between geopolymer and OPC cement concrete’, Construction and Building Materials, no. 43, pp. 125-130.
van Deventer, J. S. J. Provis, J. L.& Duxson, P. 2012, ‘Technical and commercial progress in the adoption of geopolymer cement’, Minerals Engineering, no. 29, pp. 89-104.
de Vargas, A. S. Molin, D. C. C. D. Maseuro, A. B. Vilela, A. C. F. Castro-Gomes, J. & de Gutierrez, R. M. 2014, ‘Strength development of alkali-activated fly ash produced with combined NaOH and Ca(OH)₂ activators’, Cement and Concrete Composites, vol 53, pp. 341-349.
Wang, S-D. Pu, X-C. Scrivener, K. L.& Pratt, P. L. 1995, ‘Alkali-activated slag cement and concrete: a review of properties and problems’, Advances in cement research, vol 7, no. 27, pp. 93-102.
Wang, S-D. Scrivener, K. L.& Pratt, P. L. 1994, ‘Factors affecting the strength of alkali-activated slag’, Cement and Concrete Research, vol 24, no. 6, pp. 1033-1043.
Wang G. C. 2016. ‘The Utilization of Slag in Civil Infrastructure Construction’. Woodhead Publishing.
Walkley, B. Nicolas, R. S. Sani, M. A. Rees, G. J. Hanna J. V. van Deventer J. S. J. & Provis J. L. 2016, ‘Phase evolution of C-(N)-A-S-H/N-A-S-H gel blends investigated via alkali-activated of synthetic calcium aluminosilicate precursors’, Cement and Concrete Research, vol 89, pp. 120-135.
WBSCD 2009, Recycling Concrete, viewed 8 Jan. 2018, <http://www.wbcsdcement.org/pdf/CSI-RecyclingConcrete-FullReport.pdf>.
Yuan, X-H. Chen, W. Lu, Z-A.& Chen, H.2014, ‘Shrinkage compensation of alkali-activated slag concrete and microstructural analysis’, Construction and Building Materials, vol 66, pp. 422-428.
Yuan, B. Yu, & Q. Brouwers, H. J. H. 2017, ‘Assessing the chemical involvement of limestone powder in sodium carbonate activated slag’, Materials and Structures, vol 50, no. 2, pp. 1-14.
Zhu, Q. 2011, CO₂ abatement in cement industry, viewed 8 Jan. 2014, <http://www.iea-coal.org.uk/documents/82745/8189/co2-abatement-in-the-cement-industry>.

1. A cementitious composition comprising:
a binder consisting of a source of fly ash and a source of amorphous (reactive) silica; and
a chemical activator,
wherein
the chemical activator comprises a combination of Na₂CO₃ and a source of calcium, wherein the source of calcium is selected from the group consisting of Ca(OH)₂, CaO, and mixtures thereof; and
the composition is cured at ambient or elevated temperature and used for in situ or precast applications.

2. The cementitious composition of claim 1, wherein the source of amorphous (reactive) silica present in the composition is from 1 to 20 wt % of fly ash mass.

3. The cementitious composition of claim 1, wherein the Na₂CO₃ present in the composition is between 3 and 15 Na₂O_{N} wt % of fly ash mass.

4. The cementitious composition of claim 1, wherein the source of calcium present in the composition is between 3.5 and 20 CaO wt % of fly ash mass.

5. The cementitious composition of claim 1, wherein the composition is cured at ambient temperature in situ.

6. A method for manufacturing concrete, morter or grout, wherein the method comprises the use of the cementitious composition of claim 1.

7. A process for the preparation of a dry mixed ready-to-use cementitious composition, the process comprising the steps of:
(i) providing a binder consisting of a source of fly ash and a source of amorphous (reactive) silica;
(ii) providing a chemical activator comprising a combination of Na₂CO₃ and a source of calcium, wherein the source of calcium is selected from Ca(OH)₂, CaO, and a mixture thereof; and
(iii) mixing the binder and chemical activator in one step.

8. A concrete, mortar or grout product or the like prepared according to the process of claim 7.

9.-12. (canceled)
